(19) United States
(12) Patent Application Publication
(10) Pub. No.: US 2008/0315026 A1
(43) Pub. Date: Dec. 25, 2008

(54) Multi-task Fly Line Machine

(76) Inventor: John Carl Sleeper, (US)

Correspondence Address: JOHN C. SLEEPER, P.O. BOX 217, CRIPPLE CREEK, CO, 80813, US

(21) Appl. No.: 11/767,490

(22) Filed: Jun. 23, 2007

(51) Int. Cl. A01K 89/00; B65H 75/34

(52) U.S. Cl. 242/400

(57) ABSTRACT

The Multi-task Fly Line Machine uses spools to hold or store fly line in different phases of the operations to transfer fly line for storage or to another fly reel, clean and/or lubricate the fly line as well as a movable guide which performs the cleaning and lubricating of the fly line. There is also a removable platform to facilitate the addition of new fly line or other materials into the system. The machine functions either by use of a hand crank or use of an external power device such as a hand drill to operate the machine.

### REFERENCES CITED

U.S. Patent Documents

| | | | |
|---|---|---|---|
| 4,540,136 | September 1985 | Rauch | 242/396.9 |
| 5,725,172 | March 1998 | Koehler | 242/395 |
| 6,260,785 | July 2001 | Prais | 242/484.6 |
| 6,533,210 | March 2003 | Berke | 242/470 |

### FIELD OF THE INVENTION

Within a compact area all the functions necessary to accomplish all the functions claimed can be done in any area of a home or business or in the field where a solid surface is available to support the machine.

### BACKGROUND OF THE INVENTION

Previously, the task of performing all the functions claimed were a time consuming and messy job. The aim of this machine is to consolidate all the functions claimed into one compact area where previously the amount of room required to perform the functions claimed would take up a number of times the area used by this machine. The previous way of cleaning and lubricating fly line, changing and storing fly line was to do it by hand which was both time consuming and strenuous. Cleaning and lubricating the fly line by hand usually required mounting the fly reel on a reel seat, normally on the fly pole which makes the operation unwieldy unless 2 or more people are involved.

### SUMMARY OF THE INVENTION

The need and use of this invention is to enable anyone to have a simple and easy method for maintaining fly line to increase longevity of the fly line as well as the practical usability of the fly line. The reason this invention will accomplish its stated goals is that the ease and convenience will prompt good maintenance habits.

### BRIEF DESCRIPTION OF THE DRAWINGS

The machine is comprised of:

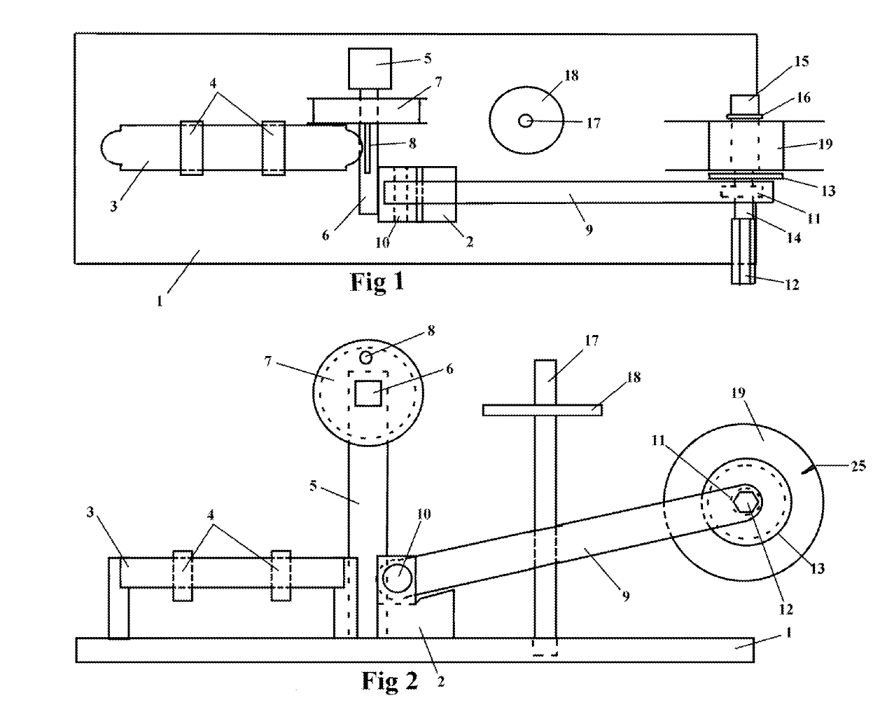

1) The base unit, FIGS. 1 & 2, show in two elevations the basic arrangement of the machine.

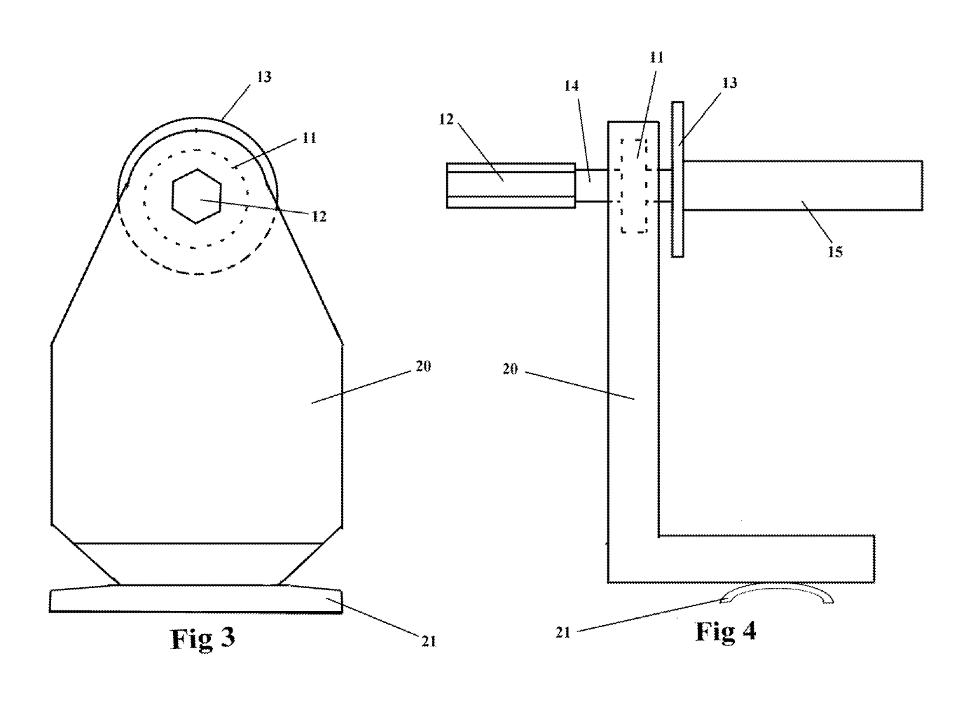

2) FIGS. 3 & 4 show in two elevations the transfer reel which is used to transfer fly line from one storage spool to another or from a supply spool to a storage spool.

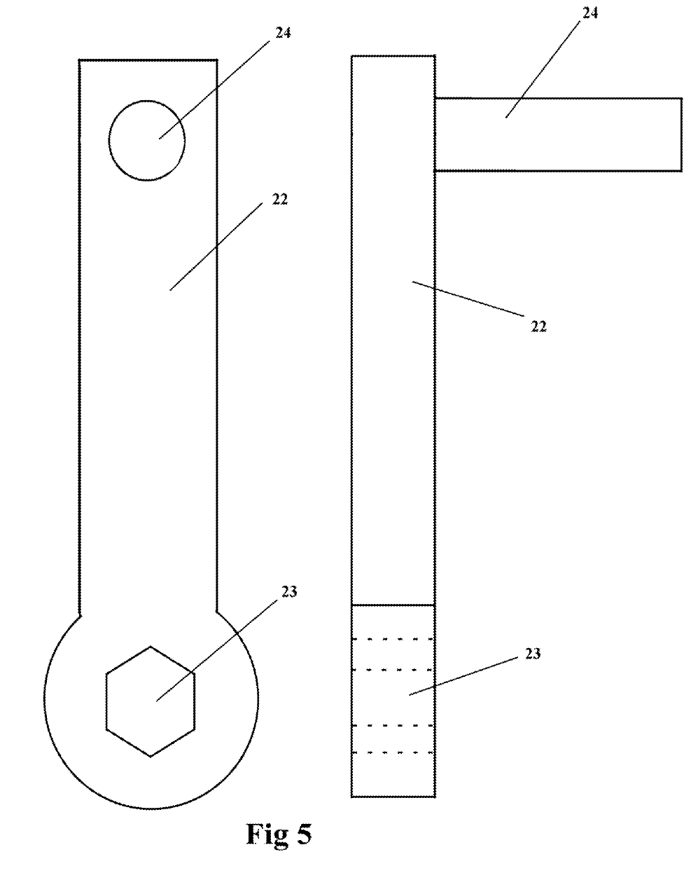

3) FIG. 5 is the two elevation drawing of the manual crank used to turn the rotating shaft on the transfer reel and/or the storage spool arm (12) of the base unit if it is not desired to use a power drill for this operation.

### DETAILED DESCRIPTION OF THE PREFERRED EMBODIMENT OF THE INVENTION

All identical numbers enclosed in parentheses referring to portions of the mechanism in any portion of the drawings depicted in FIGS. 1-4 are identical in all particulars with the only difference being where they are used in the mechanism. Fishing reels of any type (i.e.—fly reel, level wind reel, spinning reel and etc.) may be used in this description where ever a fly reel is called for.

1) The base unit, FIGS. 1 & 2, consists of a rod seat (3) fitted with a mechanism (4) for holding a fly reel or the transfer reel (FIGS. 3 & 4) in a fixed position solidly while line is either removed from or put on the reel. A vertical column (5) with square horizontal arm (6) (the cleaning/lubricating arm) used for mounting a removable cleaning/lubricating spool (7) with a fixed handle (8) used to slide the cleaning/lubricating spool along the horizontal arm. A hinged long arm (the storage spool arm) (9) with a rotating shaft fixed at the top of the storage spool arm consisting of a hexagonal end (12) where either a hand crank (FIG. 5) or a variable speed power drill can be attached, leading to a round portion of the shaft (14) leading through the storage spool arm (9) to the thrust bearing (11) then out the other side of the storage spool arm (9) to a stop plate (13) which is used to keep a storage spool (19) away from the non-rotating part of the mechanism when mounted on the square end of the shaft (15) which keeps the storage spool (19) from freely rotating about the shaft. The storage spool is retained on the square end of the shaft by a rubber retaining ring (16). The storage spool arm (9) is attached to a support block (2) via a hinge pin (10) to maintain the rotating shaft end of the arm above the base plate (1) at a distance to preclude a mounted storage spool from scraping the base plate while being rotated while additionally giving the arm enough movement to accommodate being attached to a variable speed power drill of any of the most common sizes available. The storage spool arm (9) and the reel seat (3) must be positioned so that when a storage spool (19) is attached to the storage spool arm it is in line with the reel seat (3). A removable spindle (17) is attached to the base by slipping the end into a hole of the proper size in the base plate and having a fixed, non-rotating plate (18) near the top of the spindle for supporting supply spools of line backing, new fly line, tippet or the like while attaching and feeding their contents to the fly line system in the normal way.

2) The round cleaning and lubricating spools (7) are alternately mounted on the square cleaning/lubricating arm (6) via the square arbor running concentrically through the barrel of the spool depending on whether you are cleaning or lubricating the line. The surface of the traverse portion of the barrel between the flanges of the cleaning/lubricating spool is coated with a replaceable lint-free fabric of sufficient depth of pile to engulf the fly line passed over its surface and retain cleaning and lubricating fluids used in the cleaning and lubricating operations of the mechanism.

3) The round storage spools (19) are of sufficient size to hold all the fly line and backing for any size fly reel. These storage spools are used for both storage and transfer of fly line. The notch in the flanges of the storage spool (25) are for securing the line during winding.

4) The all purpose spindle consists of a round vertical spindle (17) with a round flat integral plate (18) near the top capable of supporting supply spools of fly line, fly line backing, tippets and etc.

5) The transfer reel shown in FIGS. 3 & 4 is used to transfer fly line from one storage spool to another during different operations. The transfer reel is comprised of a body (20) with a reel mounting foot (21) attached to the bottom to allow secure mounting of the mechanism to the reel seat (3) and held in place by retaining mechanism (4). It has a rotating shaft fixed at the top of the body consisting of a hexagonal end (12) where either a hand crank (FIG. 5) or a variable speed power drill can be attached, leading to a round portion of the shaft (14) leading through the transfer reel body (20) to the thrust bearing (11) then out the other side of the transfer reel body (20) to a stop plate (13) which is used to keep a storage spool (19) away from the non-rotating part of the mechanism when mounted on the square end of the shaft (15) which keeps the storage spool (19) from freely rotating about the shaft. The storage spool is retained on the square end of the shaft by a rubber retaining ring (16).

6) Manual hand cranks (FIG. 5) are used to manually turn the rotating shafts on the storage spool arm (9) and the transfer reel (FIGS. 3 & 4). These hand cranks are comprised of a shaft (22) with a hexagonal hole (23) at one end capable of fitting the hexagonal end of the rotating shafts of the storage spool arm and the transfer reel and a round fixed handle (24) at the other end for ease of turning the crank manually.

7) The retainer rings (16) are used to secure the storage spools (19) on to the square shafts (15) snugly against the stop plate (13).

8) The method for accomplishing the functions in claims 1-12 is to attach a fly reel or transfer reel (FIGS. 3 & 4) to the reel seat (3) in the normal manner with the handle of the fly reel or the hexagonal end (12) of the transfer reel (FIGS. 3 & 4) toward the user. A manual hand crank (FIG. 5) or a variable speed power drill may be attached to the hexagonal end (12) of the rotating shafts in FIGS. 1-4. Thus configured a supply spool of any of various materials used in the normal fly line system can be mounted on the all-purpose spindle (17) to rest on top of the support plate (18) when the spindle is mounted in the proper hole in the base plate (1). Thus the line from the supply spool may be connected to either the fly reel, or a storage spool (19) mounted on the square end of the rotating shaft (15) on either the hinged storage spool arm (9) or the transfer reel (FIGS. 3 & 4). These transfers of line may be accomplished by additionally looping the line around the cleaning/lubricating spool (7) to be cleaned or lubricated as desired. Transferring line between a fly reel and a storage spool (19) or between two different storage spools, as would be the case when the transfer reel (FIGS. 3 & 4) is used, is accomplished by looping the line when fed from a storage spool (19) or a fly reel around the cleaning/lubricating spool (7) to either an empty fly reel or storage spool (19). If no cleaning or lubricating of the line is desired during the transfer the cleaning/lubricating spool may be removed during the transfer. Using these methods, line may be transferred to and from reels or storage spools as desired for use or storage thus accomplishing all claims in one compact and simple method.

What is claimed is:

1. The functions of this machine allow the following claims to be met:
1) Clean, inspect, remove and store the fly line in one operation,
2) Put on new fly line and backing and lubricate all at once,
3) Clean, lubricate and inspect the fly line on the fly reel in one quick operation.
